(19) United States
(12) Patent Application Publication
(10) Pub. No.: US 2013/0041058 A1
(43) Pub. Date: Feb. 14, 2013

(54) COMPOSITION CONTAINING TIN AND/OR ZINC SALTS OF RICINOLEIC ACID AND AT LEAST ONE FURTHER TIN CARBOXYLATE AND USE OF THE COMPOSITION IN THE PRODUCTION OF POLYURETHANE SYSTEMS

(71) Applicants: Eva Emmrich-Smolczyk, Essen (DE); Harald Modro, Gladbeck (DE)

(72) Inventors: Eva Emmrich-Smolczyk, Essen (DE); Harald Modro, Gladbeck (DE)

(73) Assignee: EVONIK GOLDSCHMIDT GmbH, Essen (DE)

(21) Appl. No.: 13/584,349

(22) Filed: Aug. 13, 2012

(30) Foreign Application Priority Data
Aug. 11, 2011 (DE) DE102011110016.8

(51) Int. Cl. C08G 18/24; C08J 9/12; C08G 18/32

(52) U.S. Cl. 521/125; 502/170; 502/167; 502/158; 521/126

(57) ABSTRACT

The invention relates to a composition, in particular a composition suitable for catalysis of the production of polyurethane systems, which is characterized in that the composition comprises at least one tin ricinoleate and/or zinc ricinoleate and at least one further tin carboxylate which is not a tin ricinoleate.

### FIELD OF THE INVENTION

The present invention relates to compositions, in particular compositions suitable for catalysis of the production of polyurethane systems, comprising at least one tin and/or zinc ricinoleate and at least one further tin carboxylate which is not a tin ricinoleate.

### BACKGROUND OF THE INVENTION

Polyurethane systems are, for example, polyurethane coatings, polyurethane adhesives, polyurethane sealants, polyurethane elastomers or polyurethane foams.

Polyurethane foams are used in a variety of fields because of their excellent mechanical and physical properties. A particularly important market for a variety of types of PUR foams such as conventional flexible foams based on ether polyols and ester polyols, cold-cure foams (frequently also referred to as HR foams), rigid foams, integral foams and microcellular foams and also foams whose properties lie between these classifications, e.g., semirigid systems, is the automobile industry and the furniture industry. For example, rigid foams are used as roof interior, ester foams are used for the interior lining of doors and for stamped-out sun visors, cold-cure and flexible foams are used for seat systems and mattresses.

Catalysts suitable for one-component moisture-reactive polyurethane compositions usually contain tin compounds such as tin carboxylates, in particular tin octoate (such as tin 2-ethylhexanoate), frequently combined with tertiary amines

The use of tin octoate in the production of flexible PUR foams based on polyetherols is described, for example, in Steve Lee, Huntsman Polyurethanes, The Polyurethanes Book, Wiley, pp. 140, 143-144. Tin octoate serves as a catalyst for the reaction of isocyanates with polyols (also referred to as gel catalyst) via a complex transition state. During the production of the foam, tin octoate hydrolyses and liberates both the salt of 2-ethylhexanoic acid and also the acid itself. Although the decomposition is desirable because the backreaction of the urethane bond to the starting materials is suppressed in this way, it should if possible not lead to liberation of any substances which are of toxicological concern. The patent literature also contains numerous applications which describe the use of tin octoate, e.g., GB 1432281, GB 1422056, GB 1382538, GB 1012653 or GB 982280. In these documents, catalyst systems comprising tin octoate are used as preferred catalyst systems.

Dibutyltin dilaurate (DBTDL) is one of the most efficient catalysts in the production of polyurethane foams, in particular high resilience (HR) polyurethane foams, in particular by the slabstock method, because in this case it is important to make the density distribution over a large foam block as homogeneous as possible. For health and ecotoxicological reasons, the use of DBTDL is increasingly avoided in the production of polyurethane foams.

To meet the demands made of the automobile and furniture industry and their foam suppliers in respect of emissions and toxicity specifications, which have become significantly more stringent in recent years, catalyst systems which contain less toxic ligands polymerized into the foam have been developed. Such systems based on, for example, ricinoleic acid are described, for example, in EP 1013704.

The abovementioned systems have to date been one of the few alternatives to the widespread tin octoate catalyst system (tin(II) salt of 2-ethylhexanoic acid) or organotin compounds such as dibutyltin dilaurate. The latter systems, in particular, are critical in terms of the toxicity of the substances emitted. For example, the 2-ethylhexanoic acid liberated during and after foaming gives cause for concern because of possible risk of harm to the unborn child (harm to foetal development) in human beings (R 63).

However, tin carboxylates, which can be used as alternative catalysts, frequently lead to large density fluctuations in the resulting foam block, which also have effects on the dimensional stability.

Foam blocks are usually processed to produce mattresses by cutting the block into uniform slices. A homogeneous distribution of the density over the entire foam block is particularly important. Mechanical properties such as the indentation resistance are linked to the density. When slices, e.g., mattresses, are cut from a severely deformed polyurethane foam block, large quantities of scrap are obtained.

### SUMMARY OF THE INVENTION

It is therefore an object of the present invention to provide an alternative catalyst system for producing polyurethanes, in particular polyurethane foams, which overcomes the abovementioned disadvantages. The catalyst system according to the invention has only small amounts of, and preferably no, DBTDL and when used as a catalyst in the production of HR polyurethane foams makes it possible to obtain foam blocks which have a very homogeneous density distribution.

It has surprisingly been found that compositions which comprise tin ricinoleate and/or zinc ricinoleate and also at least one further tin carboxylate achieved this object.

The present invention accordingly provides a composition, in particular a composition suitable for catalysis of the production of polyurethane systems, which is characterized in that the composition comprises at least one tin ricinoleate and/or zinc ricinoleate and at least one further tin carboxylate which is not a tin ricinoleate, and also a polyurethane system which comprises a composition according to the invention.

The present invention likewise provides for the use of the compositions of the invention as catalyst systems in the production of polyurethane systems, preferably polyurethane coatings, polyurethane adhesives, polyurethane sealants, polyurethane elastomers or polyurethane foams and also the use of polyurethane systems according to the invention as refrigerator insulation, insulation board, sandwich element, pipe insulation, spray foam, 1- & 1.5-component pressure-pack foam, imitation wood, modelling foam, packaging foam, mattress, furniture upholstery, automobile seat upholstery, headrest, dashboard, automobile interior trim, automobile interior roof, sound absorption material, steering wheel, shoe sole, carpet backing, filter foam, sealing foam, sealant and adhesive or for producing these products.

The compositions of the invention have the advantage that they can be used as a catalyst system both for producing flexible foams based on ether polyols and ester polyols and also for producing rigid foams and also foams whose properties lie between these classifications, e.g., semirigid foams.

The compositions of the invention have the great advantage that the viscosity of the composition can be set in a targeted manner by selection of the carboxylate radicals in the tin carboxylates. In addition, properties such as tin content, molecular weight and thus also activity or reactivity of the catalyst system can be set in a targeted manner.

The compositions of the invention have the additional advantage that they can be completely free of organotin compounds, i.e., compounds having an Sn—C bond. In particular, the compositions of the invention are free of DBTDL.

Polyurethane foam blocks produced using the compositions of the invention as catalyst systems have a relatively uniform (foam) density over the entire block. As a result of the relatively uniform foam density, polyurethane foam blocks which have only minor hardness differences within the block are obtained.

As a result of the use of the compositions of the invention as a catalyst system in the production of polyurethane foam blocks, foam blocks which have only minor deformation are obtained, so that pieces can be cut from these blocks without a great deal of scrap being produced.

### DETAILED DESCRIPTION OF THE INVENTION

The compositions of the invention, the process and the use for producing polyurethane foams, the polyurethane foams themselves and their uses are described by way of example below, without the invention being restricted to these illustrative embodiments. Where ranges, general formulae or classes of compounds are indicated below, these should be interpreted as encompassing not only the respective ranges or groups of compounds which are explicitly mentioned but also all subranges and subgroups of compounds which can be obtained by leaving out individual values (ranges) or compounds. Where documents are cited in the present description, the contents thereof, in particular in respect of the subjects being referred to, are to be incorporated in their entirety into the disclosure content of the present invention. Where percentages are reported below, these are, unless indicated otherwise, percentages by weight. Where averages are indicated below, these are, unless indicated otherwise, the number average. Where materials properties such as viscosities or the like are indicated below, these are, unless indicated otherwise, the materials properties at 25° C.

The composition of the invention, which is particularly suitable for catalysis of the production of polyurethane systems, is characterized in that it comprises at least one tin ricinoleate and/or zinc ricinoleate and at least one further tin carboxylate which is not a tin ricinoleate. As tin and zinc salts, preference is given to using tin(R) and zinc(R) salts.

The mass ratio of the sum of the masses of tin ricinoleate and/or zinc ricinoleate to the sum of the mass of the further tin carboxylates in the composition of the invention is preferably from 10:1 to 1:1, more preferably from 5:1 to 1.5:1 and particularly preferably from 4:1 to 2:1.

The further tin carboxylate(s) is/are preferably selected from the group consisting of monocarboxylic acid salts having from 1 to 30, preferably from 4 to 18 and particularly preferably from 8 to 12, carbon atoms, in particular tin salts of n-octanoic acid, n-nonanoic acid, 3,5,5-trimethylhexanoic acid, n-decanoic acid or 2-ethylhexanoic acid. Preferred tin carboxylates are those derived from carboxylic acids which do not have exclusively a single ethyl or n-propyl branch in the 2 position. Particularly preferred tin carboxylates are the tin salts of 3,5,5-trimethylhexanoic acid or n-octanoic acid.

The tin and/or zinc ricinoleates and the further tin carboxylates present in the composition of the invention can be obtained, for example, by reacting the corresponding acids or salts thereof, in particular alkali metal salts, with SnCl₂. This reaction can, for example, be carried out as described in U.S. Pat. No. 4,532,262.

The compositions of the invention can consist exclusively of tin and/or zinc ricinoleate(s) and tin carboxylate(s). However, it can also be advantageous for the compositions of the invention to have one or more further components.

Thus, the compositions of the invention can contain one or more solvents such as water and/or one or more organic solvents as further components. The composition of the invention preferably contains one or more organic solvents, more preferably at least one organic aprotic solvent. If the composition of the invention contains an organic solvent, this is preferably selected from polyols, esters, polyesters, olefins, phthalates, end-capped polyethers or mineral oils. If the composition of the invention contains a solvent, the mass ratio of the sum of the masses of the tin and zinc salts to the sum of the mass of the solvent is preferably from 100:1 to 1:2, preferably from 50:1 to 1:1 and particularly preferably from 25:1 to 2:1.

The composition of the invention can have further components such as one or more amines, in particular tertiary amines, one or more silicone stabilizers and optionally one or more emulsifiers in addition to the solvent or solvents or in place of the solvents. The composition preferably consists exclusively of tin and/or zinc ricinoleate(s) and tin carboxylate(s) and optionally one or more solvents.

The composition of the invention is preferably a catalyst system for catalysis of the production of polyurethane systems or can be used as catalyst system in a process for producing polyurethane systems, preferably polyurethane coatings, polyurethane adhesives, polyurethane sealants, polyurethane elastomers or polyurethane foams. The composition of the invention is particularly preferably used as a catalyst system in a process for producing HR polyurethane foam.

The composition of the invention can therefore also be a formulation for producing a polyurethane system, in particular a polyurethane foam, containing or consisting of tin and/or zinc ricinoleate(s) and tin carboxylate(s), optionally organic solvents, one or more organic isocyanates having two or more isocyanate functions, one or more polyols having two or more groups which are reactive towards isocyanate, optionally further catalysts for the isocyanate-polyol and/or isocyanate-water reactions and/or isocyanate trimerization, water, optionally physical blowing agents, optionally flame retardants and optionally further additives.

In one embodiment, it can be advantageous for the composition of the invention as a formulation to comprise a mixture comprising urea, sugar alcohol, in particular a monosaccharide sugar alcohol of the formula CₙH2ₙ₊₂Oₙ, where n=5 or 6, preferably xylitol, d-glucitol (sorbitol) or d-mannitol, preferably d-glucitol, and polyethylene glycol, preferably having an average molecular weight Mw of from 100 to 1500 g/mol, preferably from 250 to 1000 g/mol and particularly preferably from 500 to 750 g/mol, as further additive. The weight ratio of urea to sugar alcohol is preferably from 1:1 to 1:10, more preferably from 1:1.5 to 1:5 and particularly preferably from 1:2 to 1:4. The weight ratio of urea to polyethylene glycol is preferably from 1:0.5 to 1:4, more preferably from 1:0.75 to 1:3 and particularly preferably from 1:1 to 1:2.

In the present invention, the composition of the invention can be added as a catalyst system to the reaction mixture before or during the reaction (to form the urethane bonds). The composition is preferably introduced by means of a mixing head.

As described above, the catalyst system can have further constituents such as water, tertiary amine, silicone stabilizer and optionally emulsifier. Such a solution of the catalyst is frequently referred to as activator solution. However, the catalyst system is preferably added separately, optionally dissolved in a polyether polyol.

In the process of the invention (use according to the invention), the direct introduction of a catalyst system (a composition) which comprises exclusively tin and/or zinc ricinoleate(s) and tin carboxylate(s) is preferred. In the direct introduction of the catalyst system, the mixture composed of tin and/or zinc ricinoleate(s) and tin carboxylate(s) should preferably be present in liquid form in order to ensure simple addition without the use of solvents.

Both the viscosity and the metal content of the catalyst system can be varied by altering the chain length of the acid, so that a reactivity and viscosity which is optimal for the respective system can be set. Direct introduction of the viscous tin ricinoleate (salt of ricinoleic acid) into the polyurethane system components, in particular foaming components, can, on the other hand, leads to problems because of the very high viscosity thereof. Since many foaming machines have only direct introduction, a product which can be matched individually to the given conditions is therefore of great advantage.

As an alternative to direct foaming, the catalyst system can also be introduced in diluted form. Preference is in this case given to water-free solutions since some tin/zinc salts have only limited hydrolysis stability.

The compositions of the invention (catalyst systems) can be used as catalysts in the conventional formulations for producing polyurethane systems, in particular polyurethane foams, containing or consisting of one or more organic isocyanates having two or more isocyanate functions, one or more polyols having two or more groups which are reactive towards isocyanate, optionally further catalysts for the isocyanate-polyol and/or isocyanate-water reactions and/or isocyanate trimerization, water, optionally physical blowing agents, optionally flame retardants and optionally further additives.

Suitable isocyanates for the purposes of the present invention are preferably all polyfunctional organic isocyanates, for example diphenylmethane 4,4′-diisocyanate (MDI), tolylene diisocyanate (TDI), hexamethylene diisocyanate (HMDI) and isophorone diisocyanate (IPDI). The mixture of MDI and more highly condensed analogues having an average functionality of from 2 to 4 known as “polymeric MDI” (“crude MDI”) and the various isomers of TDI in pure form or as isomer mixture are particularly suitable. Particularly preferred isocyanates are mixtures of TDI and MDI.

Suitable polyols for the purposes of the present invention are preferably all organic substances having a plurality of groups which are reactive towards isocyanates, and also preparations thereof. Preferred polyols are all polyether polyols and polyester polyols which are customarily used for producing polyurethane systems, in particular polyurethane foams. Polyether polyols are obtained by reaction of polyhydric alcohols or amines with alkylene oxides. Polyester polyols are based on esters of polybasic carboxylic acids (which can be either aliphatic, for example adipic acid, or aromatic, for example phthalic acid or terephthalic acid) with polyhydric alcohols (usually glycols). In addition, polyethers based on natural oils (natural oil-based polyols, NOPs) can be used. These polyols are obtained from natural oils such as soybean oil or palm oil and can be used in unmodified or modified form.

A suitable ratio of isocyanate to polyol, expressed as index of the formulation, is in the range from 10 to 1000, preferably from 40 to 350. This index is the ratio of isocyanate actually used to isocyanate calculated (for a stoichiometric reaction with polyol). An index of 100 represents a molar ratio of the reactive groups of 1:1.

Suitable amounts of the composition of the invention/catalyst system of the invention depend on the type of catalyst and are usually in the range from 0.01 to 5 pphp (=parts by weight of tin and zinc ricinoleates and tin carboxylates per 100 parts by weight of polyol), preferably from 0.05 to 1 pphp. In the case of, for example, 400 g of foam (400 g ˜0.114 mol of polyol), this corresponds to a molar amount of from 1*10⁻⁵ to 1*10⁻² mol.

Suitable further catalysts which can be additionally used in the process of the invention are substances which catalyze the gel reaction (isocyanate-polyol), the blowing reaction (isocyanate-water) or the dimerization or trimerization of the isocyanate. Typical examples are amines such as triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl) ether, tin compounds such as dibutyltin dilaurate and potassium salts such as potassium acetate. Preference is given to using catalysts which contain no organic tin compounds, in particular no dibutyltin dilaurate, as further catalysts.

Suitable amounts of these additional catalysts depend on the type of catalyst and are usually in the range from 0.01 to 5 pphp (=parts by weight per 100 parts by weight of polyol) or from 0.1 to 10 pphp for potassium salts.

Suitable water contents in the process according to the present invention depend on whether or not physical blowing agents are used in addition to water. In the case of purely water-blowing foams, the values are typically from 1 to 20 pphp, while if other blowing agents are additionally used, the amount used is reduced to usually 0 or from 0.1 to 5 pphp. To attain higher foam densities, neither water, nor other blowing agents are added.

Suitable physical blowing agents for the purposes of the present invention are gases, for example liquefied CO₂, and volatile liquids, for example hydrocarbons having 4 or 5 carbon atoms, preferably cyclopentane, isopentane and n-pentane, fluorinated hydrocarbons, preferably HFC 245fa, HFC 134a and HFC 365mfc, chlorofluorocarbons, preferably HCFC 141b, oxygen-containing compounds such as methyl formate and dimethoxymethane, or chlorinated hydrocarbons, preferably dichloromethane and 1,2-dichloroethane. Further suitable blowing agents are ketones (e.g., acetone) or aldehydes (e.g., methylal).

Apart from water and optionally physical blowing agents, it is also possible to use other chemical blowing agents which react with isocyanates to evolve gas, for example formic acid or carbonates.

Suitable flame retardants for the purposes of the present invention are preferably liquid organic phosphorus compounds such as halogen-free organic phosphates, e.g., triethyl phosphate (TEP), halogenated phosphates, e.g., tris(1-chloro-2-propyl)phosphate (TCPP) and tris(2-chloroethyl)phosphate (TCEP), and organic phosphonates, e.g., dimethyl methanephosphonate (DMMP), dimethyl propanephosphonate (DMPP), or solids such as ammonium polyphosphate (APP) and red phosphorus. Furthermore, halogenated compounds, for example halogenated polyols, and solids such as expandable graphite and melamine are suitable as flame retardants.

The processing of the formulations to give foams can be carried out by all processes with which a person skilled in the art would be familiar, for example manual mixing processes or preferably by means of high-pressure or low-pressure foaming machines. It is possible to use batch processes, for example for the production of molded foams, refrigerators and panels, or continuous processes, for example in the case of insulation boards, metal composite elements, blocks or spray processes.

The process of the invention or the use according to the invention make it possible to obtain polyurethane systems, in particular polyurethane foams, which are characterized in that they comprise a composition of the invention or constituents thereof. The polyurethane system of the invention preferably comprises from 0.01 to 5% by weight of tin and/or zinc ricinoleate(s) and tin carboxylate(s).

The polyurethane system of the invention is preferably a polyurethane coating, a polyurethane adhesive, a polyurethane sealant, a polyurethane elastomer, a rigid polyurethane foam, a flexible polyurethane foam, a viscoelastic foam, an HR foam, a semirigid polyurethane foam, a thermoformable polyurethane foam or an integral foam, preferably an HR polyurethane foam. In the present disclosure, the term polyurethane is used as a collective term for a polymer produced from diisocyanates or polyisocyanates and polyols or other species which are reactive toward isocyanate, e.g., amines, with the urethane bonding not having to be the exclusive or predominant bonding type. Polyisocyanurates and polyureas are expressly also included.

The polyurethane systems of the invention, in particular the polyurethane foams, can be used, for example, as refrigerator insulation, insulation board, sandwich element, pipe insulation, spray foam, 1- & 1.5-component pressure-pack foam, imitation wood, modelling foam, packaging foam, mattresses, furniture upholstery, automobile seat upholstery, headrest, dashboard, automobile interior trim, automobile interior roof, sound absorption material, steering wheel, shoe sole, carpet backing, filter foam, sealing foam, sealant and adhesive.

In the following examples, the present invention is described by way of example without the invention, whose scope is given by the total description and the claims, being restricted to the embodiments mentioned in the examples.

### EXAMPLES

Foam blocks were produced on a low-pressure foaming machine from Laader Berg model Maxfoam F8. A detailed description of the production of foam blocks may be found in DE 2142450.

The foaming machine was operated at the following parameters:
Polyol output: 250 kg/min,
75 litres barrel volume,
Mixing chamber pressure 4.5 bar,
Stirrer speed: 4500 rpm,
Air loading: 3.0 1/min

The raw materials indicated in Table 1 were used as raw materials for producing the foam blocks.

TABLE 1
Raw materials for producing the foam blocks

| | |
|---|---|
| Polyol 1 | Polyetherol, trifunctional, MW 4800, 25% styrene- |
| | acrylonitrile-filled, Bayer Material Science AG |
| Polyol 2 | Polyetherol, trifunctional, MW 6000, BASF |
| Catalyst 1 | Tegoamin B 75, a mixture of 75% of Tegoamin 33 |
| | (triethylenediamine 33% in dipropylene glycol (DPG)) + 25% |
| | of Tegoamin BDE (bis(2-dimethylaminoethyl) ether) 70% |
| | in DPG), Evonik Goldschmidt GmbH |
| Catalyst 2 | Tegoamin DEOA 85 (diethanolamine 85% in water), Evonik |
| | Goldschmidt GmbH |
| Catalyst 3 | Zinc ricinoleate, Evonik Goldschmidt GmbH |
| Catalyst 4 | Tin octoate (29%), Evonik Goldschmidt GmbH |
| Catalyst 5 | Tin ricinoleate, Evonik Goldschmidt GmbH |
| Silicone | Tegostab B 8783 LF 2, Evonik Goldschmidt GmbH |
| stabilizer | |
| Mixture 1 | Polyethylene glycol (20%), water (25%), d-glucitol (45%), |
| | urea (10%) |
| Isocyanate | Tolylene diisocyanate, TDI 80, (80% of 2,4 isomers, 20% |
| | of 2,6 isomers), Bayer Material Science AG |

The formulations indicated in Table 2 were used to produce the foam blocks. In this case, the raw materials were pumped via separate lines to the mixing head and stirred/mixed with one another in the respective mixing ratio in the mixing head. Examples C1 to C3 are comparative examples, and Example EM1 is an example according to the invention.

TABLE 2
Formulation for producing the foam blocks
(figures in parts per 100 parts of polyol)

| Example | C1 | C2 | EM1 | EM2 |
|---|---|---|---|---|
| Polyol 1 | 70 | 70 | 70 | 70 |
| Polyol 2 | 22 | 22 | 22 | 22 |
| CaCO3 | 8 | 8 | 8 | 8 |
| TDI index | 101 | 101 | 101 | 101 |
| TDI 80 | 30.18 | 30.18 | 30.18 | 31.65 |
| Water sep. | 2.2 | 2.2 | 2.2 | 1.85 |
| Catalyst 1 | 0.11 | 0.11 | 0.12 | 0.05 |
| Catalyst 2 | 1.2 | 1.2 | 1.2 | 1 |
| Mixture 1 | — | — | — | 1.5 |
| Silicone stabilizer | 0.26 | 0.26 | 0.26 | 0.26 |
| Catalyst 3 | — | — | 0.3 | 0.3 |
| Catalyst 4 | 0.16 | — | 0.12 | 0.12 |
| Catalyst 5 | — | 0.55 | — | — |

Foam blocks having an approximate size of about 1.16 m×2.03 m×2.03 m (H×W×D) were obtained.

The density and the hardness distribution (compressive strength, compressive stress) of the foam blocks produced were determined at various places in the blocks. For this purpose, the surface of the foam block was divided into 9 squares. Each foam test specimen composed of the single squares was subjected to a compressive test in accordance with DIN 53577. Here, both the compressive stress in kPa and the sag factor in accordance with ISO 2439 were measured. The sag factor is an index which indicates the relationship between the force required to compress the foam to 65% of the initial thickness and the force required to deform the foam to 25%. Compressive stresses are expressed as ratios to one another, which is why this parameter does not have a unit. The test specimens were measured by means of an H10KS universal testing machine from Tinius Olsen in the following way:

2 cm were firstly removed from the bottom zone and 1 cm was removed from each of the four sides of the foam obtained. The remaining foam core was then cut into 5 cm slices. The test specimens having dimensions of 10×10 cm were subsequently produced from these slices.

A measuring punch having dimensions of 10×10 cm was required for the compressive strength measurement and for determining the SAG factor. Here, the punch compresses the test specimen three times before the actual measurement is carried out on the fourth compression. Loading and unloading curves of the foam were recorded. For examples of measurement curves, see: Becker, Braun, Kunststoff-Handbuch, Carl Hanser Verlag, Munich, Volume 7: Polyurethane, p. 494, 1983.

The compressive stress determined at 40% compression corresponds to the compressive strength in kPa. The SAG factor is determined in a similar way, except that here the ratio of the force for compression to 65% to the force required to compress the foam to 25% is formed. vSag is then calculated from the following formula,

$$vSag = \frac{{Sag}^{Max} - {Sag}^{Min}}{{Sag}^{Min}} * 100$$

where the lowest and highest measured values of the SAG factor were employed.

The results of these determinations are shown in Table 3.

TABLE 3
Results of the testing of the density and compressive stress

| | C1 | C2 | EM1 | EM2 |
|---|---|---|---|---|
| Density in kg/m³ | | | | |
| Measurement position in the | | | | |
| foam block | | | | |
| Top | 36.4 | 37.4 | 36.6 | 36.5 |
| Middle | 40.1 | 43.0 | 39.4 | 38.5 |
| Bottom | 40.7 | 44.7 | 40.0 | 39.0 |
| Middle of side | 37.8 | 40.5 | 38.0 | 37.9 |
| Average | 38.8 | 41.4 | 38.5 | 38.0 |
| Variation % | 11.1 | 17.6 | 8.8 | 6.6 |
| Compressive strength | | | | |
| (compressive stress) at 40% | | | | |
| compression/deformation in kPa | | | | |
| Measurement position in the | | | | |
| foam block | | | | |
| Top | 3.8 | 3.5 | 3.8 | 4.0 |
| Middle | 4.5 | 4.1 | 4.2 | 4.0 |
| Bottom | 4.2 | 3.8 | 3.7 | 4.0 |
| Middle of side | 4.2 | 4.0 | 4.1 | 4.2 |
| Average | 4.175 | 3.85 | 3.95 | 4.05 |
| Variation % | 16.8 | 15.6 | 10.1 | 4.9 |
| νSag* | 33.3 | 68.4 | 21.9 | 4.7 |

As regards the density distribution, Comparative Example Cl shows that the use of only the catalyst 4 leads to a higher density variation, as does the sole use of catalyst 5 in Example C2 which results in the highest density variations.

The combination according to the invention of catalysts 3 and 4 (Examples EM1 and EM2 according to the invention) gives a significantly more homogeneous distribution of the density over the total foam block.

While the present invention has been particularly shown and described with reference to the preferred embodiments, it will be readily appreciated by those of ordinary skill in the art that various changes and modifications may be made without departing from the spirit and scope of the invention. It is intended that the present invention be understood to cover the disclosed embodiments, those alternatives which have been discussed and all equivalents thereto.

What is claimed is:

1. A composition comprising at least one tin ricinoleate, or at least one zinc ricinoleate or a combination of at least one tin ricinoleate and at least one zinc ricinoleate, and at least one further tin carboxylate which is not a tin ricinoleate.

2. The composition according to claim 1, wherein the mass ratio of the sum of the masses of the at least one tin ricinoleate and zinc ricinoleate to the sum of the mass of the further tin carboxylates is from 10:1 to 1:1.

3. The composition according to claim 1, wherein the tin carboxylates are selected from the group consisting of monocarboxylic acid salts having from 4 to 18 carbon atoms.

4. The composition according to claim 1, further comprising one or more tertiary amines, one or more silicone stabilizers and/or one or more emulsifiers as further components.

5. The composition according to claim 1, further comprising one or more organic solvents.

6. The composition according to claim 1, wherein the composition is a catalyst system for catalyzing the production of a polyurethane system.

7. A formulation for producing a polyurethane system, said formulation comprising at least one tin ricinoleate, or at least one zinc ricinoleate or a combination of at least one tin ricinoleate and at least one zinc ricinoleate, and at least one further tin carboxylate which is not a tin ricinoleate, one or more organic isocyanates having two or more isocyanate functions, one or more polyols having two or more groups which are reactive toward isocyanate, and water.

8. The formulation according to claim 7, further comprising a mixture of urea, sugar alcohol and polyethylene glycol as a further additive.

9. The formulation according to claim 8, wherein the weight ratio of urea to sugar alcohol is from 1:1 to 1:10 and the weight ratio of urea to polyethylene glycol is from 1:1 to 1:4.

10. A method of the production of polyurethane systems, comprising providing a reaction mixture of one or more organic isocyanates having two or more isocyanate functions, one or more polyols having two or more groups which are reactive toward isocyanate, and water; and reacting said reaction mixture in the presence of a catalyst system, wherein said catalyst system comprises at least one tin ricinoleate, or at least one zinc ricinoleate or a combination of at least one tin ricinoleate and at least one zinc ricinoleate, and at least one further tin carboxylate which is not a tin ricinoleate.

11. The method according to claim 10, wherein the catalyst system is added to the reaction mixture before said reacting.

12. The method according to claim 10, wherein the catalyst system is added to the reaction mixture during said reacting.

13. The method according to claim 10, wherein said catalyst system includes from 0.01 to 5% by weight of said at least one tin ricinoleate and/or said at least one zinc ricinoleate.

14. The method according to claim 10, wherein said reacting provides a polyurethane coating, a polyurethane adhesive, a polyurethane sealant, a polyurethane elastomer, a rigid polyurethane foam, a flexible polyurethane foam, a viscoelastic foam, an HR foam, a semirigid polyurethane foam, a thermoformable polyurethane foam or an integral foam.
